(19) United States
(12) Patent Application Publication
(10) Pub. No.: US 2007/0273237 A1
(43) Pub. Date: Nov. 29, 2007

(54) Alternator having stator wound with wiring

(75) Inventors: Akiya Shichijoh, Yatomi-shi (JP); Shin Kusase, Oobu-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/798,742

(22) Filed: May 16, 2007

(30) Foreign Application Priority Data
May 25, 2006 (JP) 2006-145311

(51) Int. Cl. H02K 47/00; H02K 1/00; H02K 1/22

(52) U.S. Cl. 310/180; 310/112; 310/263

(57) ABSTRACT

An alternator has a rotor and a stator. The stator has a cylindrical armature core wound with an armature wiring. The core has slots disposed along a circumferential direction of the core so as to surround the rotor. Each slot extends in an axial direction of the core and has accommodation regions aligned along a radial direction of the core. Each region receives the wiring. The regions of each slot includes an innermost region and an outermost region, respectively, disposed on both ends of the slot in the radial direction. The wiring has end portions, respectively, drawn out from the outermost regions of different slots, and the wiring has a return portion of which both ends are drawn out from the innermost regions of two different slots.

### CROSS-REFERENCE TO RELATED APPLICATION

This application is based upon and claims the benefit of priority of the prior Japanese Patent Application 2006-145311 filed on May 25, 2006 so that the contents of which are incorporated herein by reference.

### BACKGROUND OF THE INVENTION

1. Field of the Invention

The present invention relates to an alternator which has a rotor and a stator wound with an armature wiring to generate electric power from a rotational force.

2. Description of Related Art

An alternator used for a vehicle has been downsized while increasing an output power of the alternator. This alternator has a stator wound with an armature wiring, in addition to a rotor. The stator is disposed so as to surround the rotor, so that the alternator generates electric power from a rotational force received in the rotor. The stator is formed in a cylindrical shape and has many slots opened at equal intervals along a circumferential direction of the stator. Each slot penetrates through the stator along an axial direction of the stator. Each of U-shaped conductor elements is inserted into two slots, and ends of each element are, respectively, connected with ends of two other elements so as to serially connect the elements with one another. Therefore, the stator is wound with an armature wiring formed of the elements. Portions of the armature wiring protruded from the slots form a group of coil ends on each of end sides of the core in the axial direction. In each group of coil ends, particular lines called cross-over lines necessarily cross over or overlap with other lines in the axial direction.

To downsize the alternator while maintaining a high output power of the alternator, it is important to heighten a wiring occupying ratio in a slot. This ratio is defined as a ratio of a sectional area of a wiring penetrating through a slot to an area of the slot. The sectional area of the wiring is defined on a plane perpendicular to the axial direction. Further, it is important to densely dispose the coil ends including the cross-over lines.

For example, Published Japanese Patent First Publication No. 2004-350381 has disclosed a stator of an alternator. In this stator, a cylindrical stator core has a plurality of slots disposed along a circumferential direction of the core, and each slot is partitioned into six layer regions along a radial direction of the core. That is, the first to sixth layer regions of each slot are aligned in that order from the innermost layer to the outermost layer. The core is wound with a phase wiring for each of three phases, and each phase wiring is formed by serially connecting six layer wirings. Each layer wiring is formed of a continuous conductor line and is inserted into a predetermined layer region of each slot so as to go around the core along the circumferential direction. Portions of the phase wirings protruded from the slots form a group of coil ends on each of axial-directional sides (i.e., front and rear sides) of the core.

More specifically, each of the first and second layer wirings is inserted into the first and second layer regions of the slots, each of the third and fourth layer wirings is inserted into the third and fourth layer regions of the slots, and each of the fifth and sixth layer wirings is inserted into the fifth and sixth layer regions of the slots. Between predetermined slots on the rear side of the core, the first and third layer wirings are connected with each other, the third and fifth layer wirings are connected with each other, and the fifth and first layer wirings are connected with each other. Further, between predetermined slots on the front side of the core, the second and fourth layer wirings are connected with each other, the fourth and sixth layer wirings are connected with each other, and the sixth and second layer wirings are connected with each other. Each of the first and second layer wirings is cut out between other predetermined slots on the rear side of the core, and cut end portions of the first and second layer wirings extending from the second layer regions of different slots are connected with each other to form a return portion of the phase wiring. The other cut end portion of the first layer wiring extending from the first layer region is called an outlet line. The other cut end portion of the second layer wiring extending from the first layer region is called a neutral point leading line. The neutral point leading lines of the phase wirings are connected with one another, and the outlet lines of the phase wirings are connected with a regulator. Therefore, the phase wirings form a three-phase alternating current wiring having an Y connection.

Because each layer wiring is continuously formed in advance as a single line, no connections of conductor elements are required to form each layer wiring. Therefore, this alternator can be downsized, and productivity can be greatly improved.

However, in this stator of the Patent Publication, because each of the outlet lines, neutral point leading lines and return lines of the phase wirings is drawn out from the first or second layer region, the lines are placed inevitably close to one another in a group of coil ends on the rear side of the core. Therefore, the lines become easily in contact with one another. To prevent the lines from being in contact with one another, the lines are disposed to cross over or overlap with one another along an axial direction of the core, so that a height of the group of coil ends along the axial direction becomes large. In this case, to secure an open space between the coil end group of the phase wirings and a frame covering the stator, a size of the frame becomes large along the axial direction. Therefore, the alternator is undesirably enlarged along the axial direction.

Further, in this stator, a connection line between the sixth and second layer wirings inevitably crosses over both a connection line between the second and fourth layer wirings and a connection line between the fourth and sixth layer wirings on the front side of the, core, and a connection line between the fifth and first layer wirings inevitably crosses over both a connection line between the first and third layer wirings and a connection line between the third and fifth layer wirings on the rear side of the core. Therefore, this arrangement of the phase wirings also enlarges the alternator along the axial direction.

### SUMMARY OF THE INVENTION

An object of the present invention is to provide, with due consideration to the drawbacks of the conventional alternator, an alternator wherein a stator is wound with an armature wiring so as to reduce a height of a coil end group of the armature wiring in an axial direction of the stator.

According to an aspect of this invention, the object is achieved by the provision of an alternator comprising a rotor generating a magnetic flux rotated around a rotational axis from a rotational force, and a stator generating an electric power from the rotated magnetic flux. The stator comprises an armature core and an armature wiring. The armature core is substantially formed in a cylindrical shape and has a plurality of slots disposed along a circumferential direction of the armature core so as to surround the rotor. The armature wiring is received in each of the accommodation regions of the slots, and the armature core is wound with the armature wiring by a predetermined number of turns. Each slot extends along an axial direction of the armature core. Each slot has a plurality of accommodation regions aligned along a radial direction of the armature core. The accommodation regions of each slot includes a first accommodation region and a second accommodation region, respectively, disposed on both ends of the slot along the radial direction. The armature wiring has end portions, respectively, drawn out from the first accommodation regions of different slots, and the armature wiring has a return portion of which both ends are drawn out from the second accommodation regions of two different slots.

With this arrangement of the alternator, portions of the armature wiring drawn out or protruded from the slots forms a group of coil ends on each of end sides of the armature core in the axial direction. The end portions of the armature wiring are drawn out from the first accommodation regions, and the return portion of the armature wiring is drawn out from the second accommodation regions which are furthest away from the first accommodation regions in the radial direction. Accordingly, this arrangement can prevent the end portions of the armature wiring from being disposed so as to cross over or overlap with the return portion in the axial direction, so that the height of the group of coil ends including the end portions and return portion can be lowered in the axial direction. That is, the alternator can be made in a small size in the axial direction.

### BRIEF DESCRIPTION OF THE DRAWINGS

FIG. 1 is a longitudinal sectional view of an alternator according to an embodiment of the present invention;

FIG. 2 is a view schematically showing a winding structure of a phase wiring wound around a stator of the alternator shown in FIG. 1;

FIG. 3 is a perspective side view of one of six continuous conductor members forming one phase wiring;

FIG. 4 schematically shows an armature winding formed in Y-connection; and

FIG. 5 is a perspective side view of a plurality of segment conductor members to be serially connected with one another according to a modification of this embodiment.

### DETAILED DESCRIPTION OF THE PREFERRED EMBODIMENTS

An embodiment and its modifications according to the present invention will now be described with reference to the accompanying drawings, in which like reference numerals indicate like parts, members or elements throughout the specification unless otherwise indicated.

### Embodiment

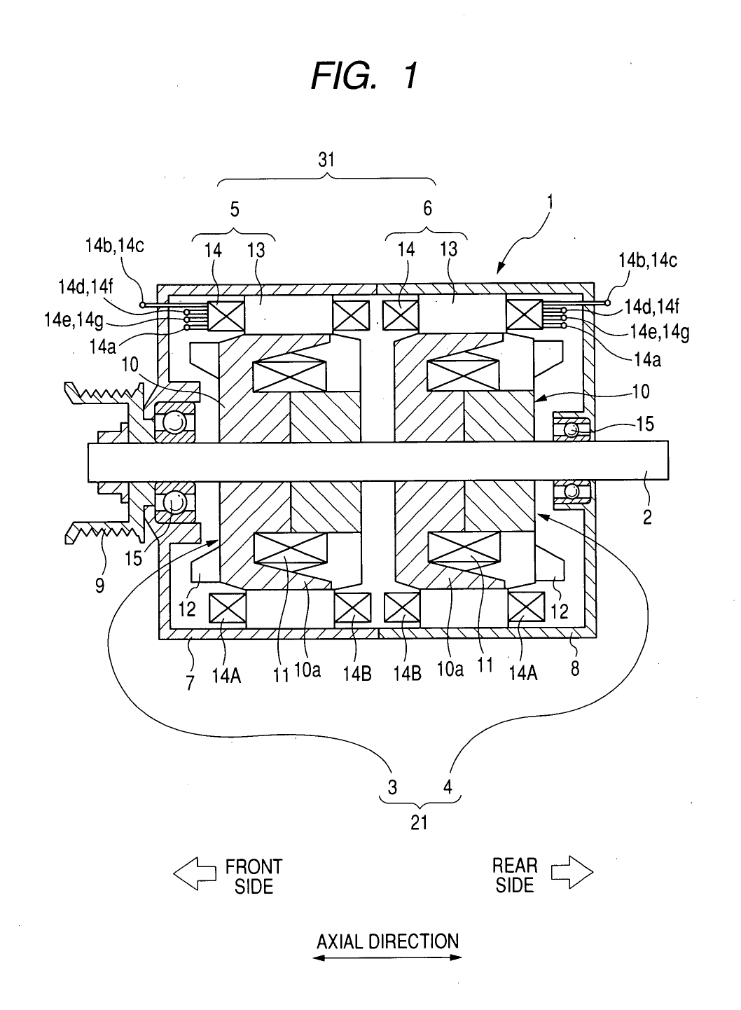

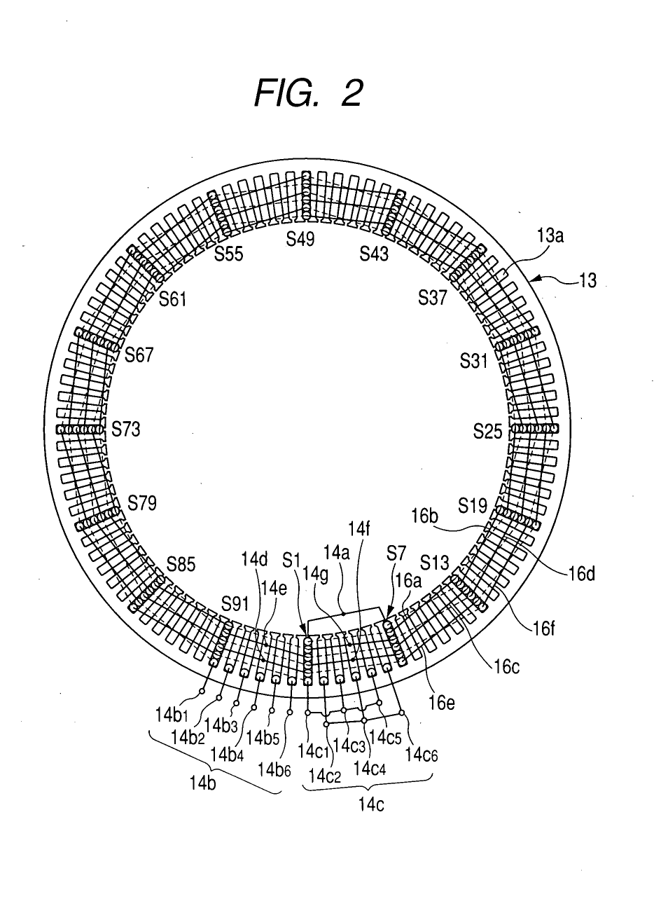

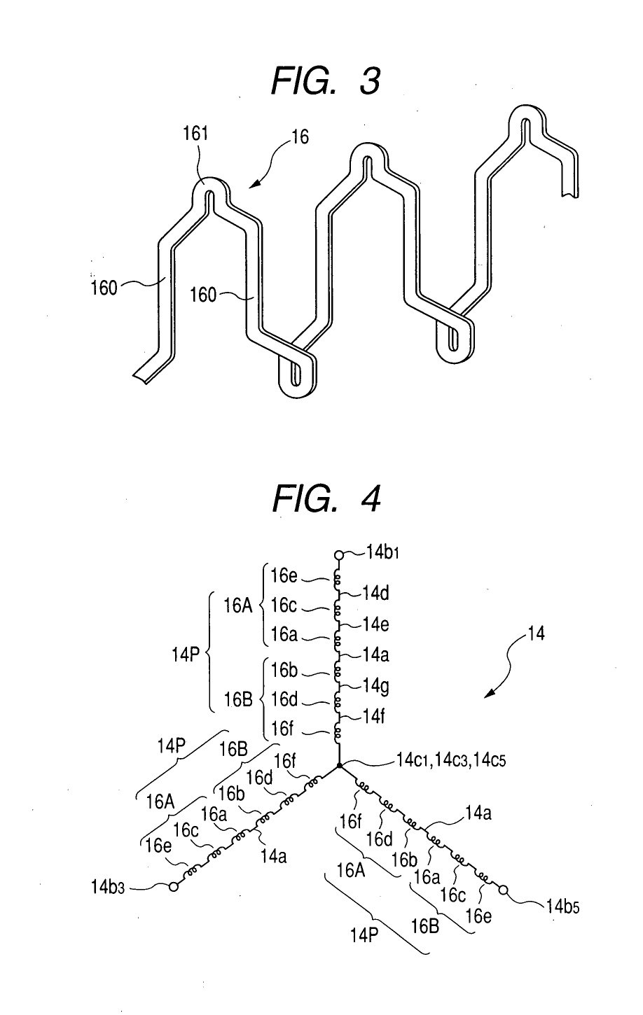

FIG. 1 is a longitudinal sectional view of an alternator according to an embodiment. FIG. 2 is a view schematically showing a winding structure of a phase wiring wound around a stator of the alternator. FIG. 3 is a perspective side view of each of six continuous conductor members forming one phase wiring.

A tandem alternator 1 shown in FIG. 1 is, for example, mounted on a vehicle. As shown in FIG. 1, the alternator 1 has a rotational shaft 2 being rotatable in response to a rotational force, a rotor section 21 being rotatable with the shaft 2 and generating a magnetic flux rotated around a rotational axis of the rotational shaft 2 from the rotational force, and a stator section 31 generating an electric power from the rotated magnetic flux.

The alternator 1 may further have a pulley 9 on a front side of the alternator 1, a front frame 7 with which front portions of the sections 21 and 31 are covered, and a rear frame 8 with which rear portions of the sections 21 and 31 are covered. The pulley 9 receives a rotational force from an engine (not shown) through a belt (not shown) wound around the pulley 9.

The rotor section 21 has a first rotor 3 and a second rotor 4 disposed tandem around the shaft 2 so as to align the pulley 9, the first rotor 3 and the second rotor 4 in that order along an axial direction of the alternator 1. Each rotor is formed substantially in a columnar shape. The stator section 31 has a first stator 5 disposed along a circumferential surface of the first rotor 3 and a second stator 6 disposed along a circumferential surface of the second rotor 4. Each stator is formed substantially in a cylindrical shape.

Each of the rotors 3 and 4 has a field core 10 fixed to the shaft 2, a field coil 11 wound around the core 10 through a bobbin (not shown), and a cooling fan 12 fixed to the core 10. Each core 10 is formed of a pair of Lundell type pole cores facing each other along the axial direction. Each pole core has a plurality of (e.g., eight) nail-shaped magnetic poles 10a aligned along a circumferential direction of the rotor. The poles 10a of one pole core and the poles 10a of the other pole core are alternately disposed along the circumferential direction.

Each coil 11 is electrically connected with a pair of slip rings (not shown) wound around the shaft 2 on its rear side. Each slip ring is rotatably in contact with a brush element of a brush apparatus such that each coil 11 receives a field current from an on-vehicle battery (not shown) through the brush apparatus and the slip rings.

Each fan 12 is fixed to an end surface of the core 10 in the axial direction by welding or the like. The fan 12 of the first rotor 3 is disposed on the front side of the rotor 3, and the fan 12 of the second rotor 4 is disposed on the rear side of the rotor 4.

Each of the stators 5 and 6 has an armature core 13 substantially formed in a cylindrical shape and two three-phase armature wirings 14 wound around the core 13. Each three-phase armature wiring 14 has three phase wirings 14P (see FIG. 2) connected with one another. Each phase wiring 14P is wound around the corresponding core 13 in the same manner as the other phase wirings 14P.

As shown in FIG. 2, each core 13 has a plurality of slots 13a disposed at equal intervals along the circumferential direction so as to surround the corresponding rotor 3 or 4. Each slot 13a penetrates through the core 13 along the axial direction. Each phase wiring 14P is received in each of corresponding slots 13a so as to surround the corresponding rotor 3 or 4 by a predetermined number of turns (e.g., six turns).

The number of slots 13a in each core 10 is determined as follows. The slots 13a receiving one of two armature wirings 14 are differentiated from the slots 13a receiving the other armature wiring 14. Because the number of magnetic poles in each core 10 is sixteen, each of three phase wirings 14P of the wiring 14 is received in sixteen slots 13a. Therefore, the total number of slots 13a in each core 13 is set at 96 (=16×3×2) for six phase wirings 14P of two armature wirings 14.

The front frame 7 is disposed on the side of the pulley 9, and the rotor 3 and stator 5 are covered with the frame 7. The frame 7 rotatably holds a front portion of the shaft 2 through a set of bearings 15. The rear frame 8 is disposed on the opposite side of the pulley 9, and the rotor 4 and stator 6 are covered with the frame 8. The frame 8 rotatably holds a rear portion of the shaft 2 through another set of bearings 15.

With this arrangement of the alternator 1, when a rotational force of an engine (not shown) of a vehicle is transmitted to the pulley 9 through a belt (not shown), the shaft 2 is rotated with the pulley 9, and each of the rotors 3 and 4 are rotated with the shaft 2. Further, the field coil 11 of each rotor receives a field current from a battery (not shown) of the vehicle though a brush apparatus. The field current is changed to an alternating current by the slip rings. Therefore, each rotor having the magnetic poles generates a magnetic flux rotated around a rotational axis of the shaft 2, and each of the stators 5 and 6 induces an electric current in response to the rotated magnetic flux of the corresponding rotor. A voltage of this induced current is adjusted in a voltage controller (not shown) and the induced current is changed to a direct current in a rectifier (not shown). Therefore, the alternator 1 can generates an electric power. The induced current is transmitted to current consumers (not shown) and the battery.

Next, a winding structure of each armature winding 14 is described in detail with reference to FIG. 2.

Each armature winding 14 is obtained by connecting three phase wirings 14P with one another in Y-connection. Each phase wiring 14P is obtained by serially connecting six continuous conductor members 16 shown in FIG. 3. Each conductor member 16 is made of copper and is formed in a belt-like shape. The member 16 is formed in a rectangular shape in section. The member 16 is covered with an insulation film. Before being wound around the core 10, the member 16 is bent to be shaped in a predetermined shape pattern shown in FIG. 3. The member 16 having this shape is continuously formed without joints or seams. The member 16 has sixteen straight portions 160 and fifteen U-shaped turn portions 161 alternately disposed. Each member 16 is wound around the core 13 by one turn so as to place the straight portions 160 into corresponding sixteen slots 13a disposed every six slots and to place the turn portions 161 outside the core 13. Each of these sixteen slots 13a receives the six members 16 of one phase wiring 14P. The six members 16 received in the slots 13a are serially connected to form one phase winding 14P. The turn portions 161 of the wirings 14 in each stator form a group of coil ends on each of both axial-directional sides of the stator.

For convenience of explanation, the slots 13a are identified by slot numbers S1 to S96 and are called S1-numbered slot, S2-numbered slot, - - - , and S96-numbered slot. The slots 13a are numbered so as to be counterclockwise arranged in the order of increasing the slot number. Each slot 13a has six accommodation regions aligned along a radial direction of the core 13 to receive six straight portions 160 of six members 16 of one phase wiring 14P in the accommodation regions. Two accommodation regions of each slot 13a, respectively, disposed on both ends of the slot in the radial direction are called an innermost region of a first address and an outermost region of a six address. Further, the other accommodation regions of each slot 13a are called a first middle region of a second address, a second middle region of a third address, a third middle region of a fourth address, and a fourth middle region of a fifth address along a direction from the inner circumferential side to the outer circumferential side of the cylindrical shaped core 13. The six members 16 are called a first wiring 16a, a second wiring 16b, a third wiring 16c, a fourth wiring 16d, a fifth wiring 16e and a sixth wiring 16f. The members 16 are serially connected in the order of the wirings 16e, 16c, 16a, 16b, 16d and 16f, as described later in detail.

Each member 16 of the phase wiring 14P is received in a first slot group composed of the S1-numbered slot 13a, the S7-numbered slot 13a, - - - , the S85-numbered slot 13a and the S91-numbered slot 13a disposed every six slots so as to go around the core 13 along the circumferential direction. Further, two accommodation regions of two predetermined addresses are alternately selected for each slot 13a to receive each member 16 in the selected accommodation region, so that the member 16 is wound around the core 13 in wave winding.

More specifically, the first wiring 16a is received in one of the innermost and first middle regions of each slot 13a while changing the address of the accommodation region every slot. Both end portions of the first wiring 16a are, respectively, drawn out from the innermost region of the S1-numbered slot 13a and the first middle region of the S91-numbered slot 13a on a specified side of the core 13. In case of the stator 5, the specified side denotes the front side (i.e., the side of the pulley 9). In contrast, in case of the stator 6, the specified side denotes the rear side (i.e., the opposite side of the pulley 9). The third wiring 16c is received in either the second middle region or the third middle region of each slot 13a while changing the address of the accommodation region every slot. Both end portions of the third wiring 16 care, respectively, drawn out from the second middle region of the S1-numbered slot 13a and the third middle region of the S91-numbered slot 13a on the specified side. The fifth wiring 16e is received in either the fourth middle region or the outermost region of each slot 13a while changing the address of the accommodation region every slot. Both end portions of the fifth wiring 16e are, respectively, drawn out from the fourth middle region of the S1-numbered slot 13a and the outermost region of the S91-numbered slot 13a on the specified side.

Further, the second wiring 16b is received in one of the innermost and first middle regions of each slot 13a while changing the address of the accommodation region every slot. Both end portions of the second wiring 16b are, respectively, drawn out from innermost region of the S7-numbered slot 13a and the first middle region of the S1-numbered slot 13a on the specified side. The fourth wiring 16d is received in either the second middle region or the third middle region of each slot 13a while changing the address of the accommodation region every slot. Both end portions of the fourth wiring 16d are, respectively, drawn out from the second middle region of the S7-numbered slot 13a and the third middle region of the S1-numbered slot 13a on the specified side. The sixth wiring 16f is received in one of the fourth middle and outermost regions of each slot 13a while changing the address of the accommodation region every slot. Both end portions of the sixth wiring 16f are, respectively, drawn out from the fourth middle region of the S7-numbered slot 13a and the outermost region of the S1-numbered slot 13a on the specified side.

Therefore, the first and second wirings 16a and 16b are alternately received in the innermost and first middle regions of the slots 13a, the third and fourth wirings 16c and 16d are alternately received in the second middle and third middle regions of the slots 13a, and the fifth and sixth wirings 16e and 16f are alternately received in the fourth middle and outermost regions of the slots 13a.

FIG. 4 schematically shows one armature winding 14 formed in Y-connection. As shown in FIG. 4, the end portion of the fifth wiring 16e drawn out from the fourth middle region of the S1-numbered slot 13a is connected with the end portion of the third wiring 16c drawn out from the third middle region of the S91-numbered slot 13a to form a connection 14d on the specific side. The end portion of the third wiring 16c drawn out from the second middle region of the S1-numbered slot 13a is connected with the end portion of the first wiring 16a drawn out from the first middle region of the S91-numbered slot 13a to form a connection 14e on the specific side. Therefore, the wirings 16a, 16c and 16e are serially connected with one another to form a wave winding 16A of three turns.

The end portion of the sixth wiring 16f drawn out from the fourth middle region of the S7-numbered slot 13a is connected with the end portion of the fourth wiring 16d drawn out from the third middle region of the S1-numbered slot 13a to form a connection 14f on the specific side. The end portions of the fourth wiring 16d drawn out from the second middle region of the S7-numbered slot 13a is connected with the end portion of the second wiring 16b drawn out from the first middle region of the S1-numbered slot 13a to form a connection 14g on the specific side. Therefore, the wirings 16b, 16d and 16f are serially connected with one another to form another wave winding 16B of three turns.

Further, the end portion of the first wiring 16a drawn out from the innermost region of the S1-numbered slot 13a is connected with the end portion of the second wiring 16b drawn out from the innermost region of the S7-numbered slot 13a to form a return portion 14a from these end portions on the specific side. Therefore, the wave windings 16A and 16B are connected with each other so as to form a first phase wiring 14P of six turns. The end portion of the fifth wiring 16e drawn out from the outermost region of the S91-numbered slot 13a forms an end portion 14b1 of the first phase wiring 14P, and the end portion of the sixth wiring 16f drawn out from the outermost region of the S1-numbered slot 13a forms an end portion 14c1 of the first phase wiring 14P. The end portion 14b1 is used as an output leading line, and the end portion 14c1 is used as a neutral point line.

In the same manner, a second phase wiring 14P of six turns is wound around the core 13 by receiving each of other six wirings 16a to 16f in a second slot group composed of the S2-numbered slot 13a, the S8-numbered slot 13a, - - - , the S86-numbered slot 13a and the S92-numbered slot 13a disposed every six slots and serially connecting the wirings 16a to 16f with one another. The second phase wiring 14P has an output leading line 14b2 drawn out from the outermost region of the S92-numbered slot 13a, a neutral point line 14c2 drawn out from the outermost region of the S2-numbered slot 13a, and another return line drawn out from the innermost regions of the S2 and S8-numbered slots 13a.

A third phase wiring 14P of six turns is wound around the core 13 by receiving each of other six wirings 16a to 16f in a third slot group composed of the S3-numbered slot 13a, the S9-numbered slot 13a, - - - , the S87-numbered slot 13a and the S93-numbered slot 13a disposed every six slots and serially connecting the wirings 16a to 16f with one another. The third phase wiring 14P has an output leading line 14b3 drawn out from the outermost region of the S93-numbered slot 13a, a neutral point line 14c3 drawn out from the outermost region of the S3-numbered slot 13a, and another return line drawn out from the innermost regions of the S3 and S9-numbered slots 13a.

A fourth phase wiring 14P of six turns is wound around the core 13 by receiving each of other six wirings 16a to 16f in a fourth slot group composed of the S4-numbered slot 13a, the S10-numbered slot 13a, - - - , the S88-numbered slot 13a and the S94-numbered slot 13a disposed every six slots and serially connecting the wirings 16a to 16f with one another. The fourth phase wiring 14P has an output leading line 14b4 drawn out from the outermost region of the S94-numbered slot 13a, a neutral point line 14c4 drawn out from the outermost region of the S4-numbered slot 13a, and another return line drawn out from the innermost regions of the S4 and S10-numbered slots 13a.

A fifth phase wiring 14P of six turns is wound around the core 13 by receiving each of other six wirings 16a to 16f in a fifth slot group composed of the S5-numbered slot 13a, the S11-numbered slot 13a, - - - , the S89-numbered slot 13a and the S95-numbered slot 13a disposed every six slots and serially connecting the wirings 16a to 16f with one another. The fifth phase wiring 14P has an output leading line 14b5 drawn out from the outermost region of the S95-numbered slot 13a, a neutral point line 14c5 drawn out from the outermost region of the S5-numbered slot 13a, and another return line drawn out from the innermost regions of the S5 and S11-numbered slots 13a.

A sixth phase wiring 14P of six turns is wound around the core 13 by receiving each of other six wirings 16a to 16f in a sixth slot group composed of the S6-numbered slot 13a, the S12-numbered slot 13a, - - - , the S90-numbered slot 13a and the S96-numbered slot 13a disposed every six slots and serially connecting the wirings 16a to 16f with one another. The sixth phase wiring 14P has an output leading line 14b6 drawn out from the outermost region of the S96-numbered slot 13a, a neutral point line 14c6 drawn out from the outermost region of the S6-numbered slot 13a, and another return line drawn out from the innermost regions of the S6 and S12-numbered slots 13a.

The neutral point lines 14c1, 14c3 and 14c5 of the first, third and fifth phase wirings 14P are connected with one another in Y-connection, so that the core 13 is wound with a first three-phase armature wiring 14 formed of the first, third and fifth phase wirings 14P. The neutral point lines 14c2, 14c4 and 14c6 of the second, fourth and sixth phase wirings 14P are connected with one another in Y-connection, so that the core 13 is wound with a second three-phase armature wiring 14 formed of the second, fourth and sixth phase wirings 14P. The output leading lines 14b1 to 14b6 of the six phase wirings 14P are connected with a regulator (not shown).

The armature wirings 14 are wound around each of the cores 13 of the stators 5 and 6. As shown in FIG. 1, in the stator 5, the turn portions 161 of the wirings 16a to 16f used for the phase wirings 14P form both a first group of coil ends 14A disposed on the front side of the core 13 and a second group of coil ends 14B disposed on the rear side of the core 13. In the stator 6, the turn portions 161 form both another first group of coil ends 14A disposed on the rear side of the core 13 and another second group of coil ends 14B disposed on the front side of the core 13.

More specifically, the turn portions 161 in each group of coil ends are disposed so as to form three layers aligned along the radial direction, and the turn portions 161 in each layer are regularly disposed along the circumferential direction such that one turn portion 161 is placed every slot. The innermost layer is formed of the turn portions 161 of the first and second wirings 16a and 16b alternately received in the innermost and first middle regions of the slots 13a. The middle layer is formed of the turn portions 161 of the third and fourth wirings 16c and 16d alternately received in the second middle and third middle regions of the slots 13a. The outermost layer is formed of the turn portions 161 of the fifth and sixth wirings 16c and 16d alternately received in the fourth middle and outermost regions of the slots 13a.

The connections 14d to 14g and return portions 14a of the armature wirings 14 of each stator are placed in the first group of coil ends 14A. These return portions 14a are disposed at the innermost position of the first group of coil ends 14A. The return portions 14a may be disposed to be shifted from the innermost position of the first group of coil ends 14A toward the core 10 of the corresponding rotor along the radial direction. That is, the return portions 14a drawn out from the innermost regions of first slots (S1 to S12-numbered slots) 13a may be shifted along the radial direction to be further away from the outermost regions of the first slots 13a. For example, the return portions 14a may be disposed between the cores 10 and 13 in the radial direction.

In contrast, the output leading lines 14b (14b1 to 14b6) and the neutral point lines 14c (14c1 to 14c6) are disposed at the outermost position of the first group of coil ends 14A toward the frame 7 or 8. The output leading lines 14b and the neutral point lines 14c maybe disposed to be shifted from the outermost position of the first group of coil ends 14A toward the frame 7 or 8 along the radial direction. That is, the lines 14b and 14c drawn out from the outermost regions of second slots (S91 to S96-numbered slots and S1 to S6-numbered slots) 13a may be shifted along the radial direction to be further away from the innermost regions of the second slots 13a. For example, the lines 14b and 14c maybe led outside the core 13 along the radial direction and penetrate through the frame 7 or 8 along the axial direction.

As described above, the end portions of the phase wirings 14P composed of the output leading lines 14b and the neutral point lines 14c are drawn out from the outermost regions of the second slots 13a placed furthest away from the innermost regions of the second slots along the radial direction, and the return portions 14a of the phase wirings 14P are drawn out from the innermost regions of the first slots coinciding with or placed near the second slots. Accordingly, this arrangement prevents the output leading lines 14b and the neutral point lines 14c from crossing over or overlapping with the return portions 14a along the axial direction in the first group of coil ends 14A.

Further, the connections 14e and 14g of the phase wirings 14P are formed between the first middle and second middle regions of the slots 13a along the radial direction, and the connections 14d and 14f of the phase wirings 14P are formed between the third middle and third middle regions of the slots 13a along the radial direction. Therefore, the connections 14d to 14g are disposed to be away from the innermost and outermost regions of the slots 13a from which the lines 14b and 14c and the return portions 14a are drawn out. Accordingly, this arrangement prevents the connections 14d to 14g from crossing over or overlapping with the output leading lines 14b, the neutral point lines 14c or the return portions 14a in the axial direction in the first group of coil ends 14A. In this case, the height of the first group of coil ends 14A of the armature windings 14 in the axial direction can be lowered, so that the alternator 1 can be downsized in the axial direction.

Moreover, the connections 14d and 14e of the armature windings 14 of each stator are disposed at positions different from those of the connections 14g and 14f in the circumferential direction, the connections 14d are disposed at positions different from those of the connections 14e in the radial direction, and the connections 14f are disposed at positions different from those of the connections 14g in the radial direction. Accordingly, this arrangement prevents lines including the connections 14d to 14g from crossing over or overlapping with one another in the axial direction in the first group of coil ends 14A, so that the height of the first group of coil ends 14A in the axial direction can be further lowered. Further, the conductor members 16 can be easily connected one another on the same side of the core 13 to form each phase wiring 14P.

Furthermore, the conductor members 16 of each phase wiring 14P are disposed without crossing over or overlapping with one another in the axial direction in each group of coil ends. Accordingly, as compared with the alternator disclosed in the Publication No. 2004-350381, the alternator 1 can be downsized in the axial direction.

Still further, each continuous conductor member 16 is bent and shaped in a predetermined shape pattern so as to be continuously formed without joints or seams. Accordingly, no connection in the armature winding 14 is required for each slot in the groups of coil ends 14A and 14B, so that the armature winding 14 can be easily wound around the core 13.

Still further, the alternator 1 is formed in a tandem structure having a first group of rotor 3 and stator 5 and a second group of rotor 4 and stator 6. The end portions 14b and 14c and return portions 14a of the phase wirings 14P in the stator 5 are placed on the front side of the core 13 opposite to the stator 6, and the end portions 14b and 14c and return portions 14a of the phase wirings 14P in the stator 6 are placed on the rear side of the core 13 opposite to the stator 5. Therefore, no end portions or return portions of the phase wirings 14P are disposed in the second group of coil ends 14B placed between the cores 13 of the stators 5 and 6. Accordingly, a distance between the stators 5 and 6 in the axial direction can be shortened, so that a tandem type alternator can downsized in the axial direction.

### Modifications

In this embodiment described above, the return portions 14a of the phase wirings 14P are drawn out from the innermost regions of the first slots 13a, while the end portions 14b and 14c of the phase wirings 14P are drawn out from the outermost regions of the second slots 13a. However, the return portions 14a of the phase wirings 14P may be drawn out from the outermost regions of the first slots 13a, and the end portions 14b and 14c of the phase wirings 14P may be drawn out from the innermost regions of the second slots 13a.

Further, six continuous conductor members 16 are, respectively, disposed in six accommodation regions of each slot 13a to be aligned in the slot along the radial direction. However, the number of accommodation regions in each slot may be set at 2n (n is an integral number equal to or larger than 2).

Moreover, three phase wirings 14P are connected with one another in Y-connection to form one armature winding 14. However, three phase wirings 14P may be connected with one another in Δ-connection to form each armature winding 14.

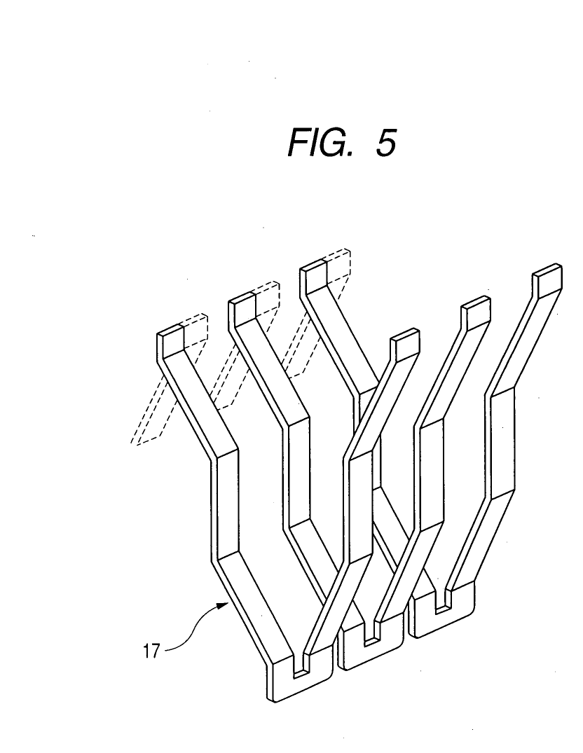

Furthermore, each conductor member 16 continuously formed in advance are inserted into sixteen slots. However, as shown in FIG. 5, eight segment conductor members 17 formed almost in a U-shape or V-shape may be used in place of the conductor member 16. Each segment conductor member 17 is received in two slots away from each other by a distant of six slots such that head portions of the members 17 form the second group of coil ends 14B, and tail portions of the members 17 are connected with one another to form the first group of coil ends 14A. Further, a long wire flexibly deformable may be used in place of the members 16 or 17 formed in a predetermined fixed shape.

Still further, this embodiment should not be construed as limiting the present invention to the alternator having a tandem structure, and the present invention can be applied for an alternator having only a single set of rotor and stator.

What is claimed is:

1. An alternator comprising:
a rotor which generates a magnetic flux rotated around a rotational axis from a rotational force; and
a stator which generates an electric power from the rotated magnetic flux, the stator comprising:
an armature core which is substantially formed in a cylindrical shape and has a plurality of slots disposed along a circumferential direction of the armature core so as to surround the rotor, each slot extending substantially in an axial direction of the armature core, each slot having a plurality of accommodation regions aligned along a radial direction of the armature core, the accommodation regions of each slot including a first accommodation region and a second accommodation region, respectively, disposed on both ends of the slot in the radial direction; and
an armature wiring which is received in each of the accommodation regions of the slots to wind the armature core with the armature wiring by a predetermined number of turns,
wherein the armature wiring has end portions, respectively, drawn out from the first accommodation regions of different slots, and the armature wiring has a return portion of which both ends are drawn out from the second accommodation regions of two different slots.

2. The alternator according to claim 1, wherein the end portions and return portion of the armature wiring are disposed on an end side of the armature core in the axial direction.

3. The alternator according to claim 1, wherein the armature wiring has a plurality of continuous conductor members serially connected with one another, each continuous conductor member is received in the slots, and two of the continuous conductor members are connected with each other in the return portion.

4. The alternator according to claim 3, wherein the end portions and return portion of the armature wiring are disposed on an end side of the armature core in the axial direction, and the continuous conductor members are connected with one another on the end side of the armature core.

5. The alternator according to claim 1, wherein the slots are partitioned into a plurality of groups such that the slots of each group surrounds the rotor, the armature wiring has a plurality of phase wirings, each phase wiring is received in each of the accommodation regions of the slots of the corresponding group so as to wind the armature core with the phase wiring by a plurality of turns, each phase wiring has two end portions, respectively, drawn out from the first accommodation regions of two different slots, and each phase wiring has a return portion of which both ends are drawn out from the second accommodation regions of two different slots.

6. The alternator according to claim 1, further comprising:
a pulley which is disposed on an end side of the rotor in the axial direction; and
a rotational shaft which receives the rotational force from an engine through the pulley,
wherein the rotor has a first rotor and a second rotor fixed to the rotational shaft and disposed so as to align the pulley, the first rotor and the second rotor in that order along the axial direction, the armature core has a first armature core surrounding the first rotor and a second armature core surrounding the second rotor, the armature wiring has a first armature wiring wound around the first armature core and a second armature wiring wound around the second armature core, the end portions of the armature wiring are classified into first end portions of the first armature wiring and second end portions of the second armature wiring, the return portion of the armature wiring are classified into first return portion of the first armature wiring and second return portion of the second armature wiring, the first end portions and first return portion of the first armature wiring are disposed on an end side of the first armature core facing the pulley along the axial direction, and the second end portions and second return portion of the second armature wiring are disposed on an end side of the second armature core opposite to the pulley along the axial direction.

7. The alternator according to claim 6, wherein the first armature wiring has a plurality of first continuous conductor members serially connected with one another on the end side of the first armature core, each first continuous conductor member is received in slots of the first armature core disposed along the circumferential direction, two of the first continuous conductor members are connected with each other in the first return portion of the first armature wiring, the second armature wiring has a plurality of second continuous conductor members serially connected with one another on the end side of the second armature core, each second continuous conductor member is received in slots of the second armature core disposed along the circumferential direction, and two of the second continuous conductor members are connected with each other in the second return portion of the second armature wiring.

8. The alternator according to claim 1, wherein the end portions of the armature wiring drawn out from the first accommodation regions of the different slots are disposed to be shifted from the first accommodation regions so as to be further away from the second accommodation regions of the different slots, and the return portion of the armature wiring drawn out from the second accommodation regions of the two slots are disposed to be shifted from the second accommodation regions so as to be further away from the first accommodation regions of the two slots.
